(19) United States
(12) Patent Application Publication
(10) Pub. No.: US 2024/0180065 A1
(43) Pub. Date: Jun. 6, 2024

(54) APPARATUS AND METHOD FOR TREATING SEEDS

(71) Applicant: Fowler Westrup (Netherlands) B. V., Medemblik (NL)

(72) Inventors: Ronny Pietersz, Medemblik (NL); Rob MEESTER, Medemblik (NL); Alex KOSTER, Medemblik (NL)

(73) Assignee: Fowler Westrup (Netherlands) B. V., Medemblik (NL)

(21) Appl. No.: 18/553,138

(22) PCT Filed: Mar. 29, 2022
(86) PCT No.: PCT/NL2022/050170

§ 371 Date: Sep. 28, 2023

(30) Foreign Application Priority Data
Mar. 29, 2021 (NL) 2027857

(51) Int. Cl. A01C 1/00

(52) U.S. Cl. CPC A01C 1/00

(57) ABSTRACT

A device for treating seeds includes a container with an internal space for containing a plurality of seeds, air humidity adjusting means for adjusting relative humidity of the air supplied to the internal space, moisture amount information obtaining means for obtaining moisture amount information about a total amount of moisture in the plurality of seeds, and control means for controlling the air humidity adjusting means on the basis of the moisture amount information obtained by the moisture amount information obtaining means during a treatment period of a treatment process for treating the plurality of seeds so that the relative humidity of the air present in the internal space is such that the total amount of moisture in the plurality of seeds follows a predetermined moisture amount development line, along which the total amount of moisture in the plurality of seeds must run during the treatment period of the treatment process.

The present invention relates to a device for treating seeds. The present invention further relates to a method for treating seeds.

A good, rapid and uniform germination of plant seeds ensures that crops develop quickly and uniformly, this making cultivation and harvesting of the crops more efficient. The germination of seeds depends on the quality of the seeds, which can generally be improved by treating the seeds with water, among other things. The so-called seed dormancy is hereby disturbed and germination processes in the seeds are set into action. This activation process is referred to as pre-germination or priming. It is however important that the treatment with water is stopped in time to prevent actual germination of the seeds. After priming, the seeds are either sown or dried in order to keep the seeds. It is known that the quality of primed seeds in respect of speed and uniformity of germination is higher than that of non-primed seeds. It is furthermore known that primed seeds keep well in dried state.

A known device and method for drying seeds make use of drying air with a relative humidity lower than the moisture content of the seeds. When the moisture content of the seeds is higher than the moisture content of the drying air, the moisture in the seeds will be released to the drying air. This will raise the relative humidity of the drying air. In order to further reduce the moisture content in the seeds the air is discharged and replaced with drier air. This process is continued until the seeds have reached the desired moisture content.

In the known device and method drying air is supplied at a relatively high air speed until the desired moisture content in the seeds has been reached. For this purpose the relative humidity of the seeds is measured in order to determine the moisture content of the seeds.

It has however been found that with the known device and method a significant proportion of the dried seeds do not possess the desired quality in respect of speed and uniformity of germination after drying thereof.

It is therefore an object of the present invention to provide an improved device and method for treating seeds, using which seeds with an improved seed quality can be obtained.

For this purpose the present invention provides according to a first aspect thereof a device for treating seeds, comprising a closable container with an internal space for containing a plurality of seeds therein, comprising an air inlet and an air outlet which are each in fluid connection with the internal space,
air displacing means configured to supply air via the air inlet to the internal space at a flow rate and to discharge the air present in the internal space via the air outlet,
air humidity adjusting means configured to adjust a relative humidity of the air to be supplied to the internal space,
air temperature adjusting means configured to adjust a temperature of the air to be supplied to the internal space,
moisture amount information obtaining means configured to obtain moisture amount information about a total amount of moisture in the plurality of seeds, and control means configured to control the air humidity adjusting means on the basis of the moisture amount information obtained by the moisture amount information obtaining means during a treatment period of a treatment process for treating the plurality of seeds, such that the relative humidity of the air present in the internal space is such that the total amount of moisture in the plurality of seeds follows a predetermined moisture amount development line, along which the total amount of moisture in the plurality of seeds must run during the treatment period of the treatment process.

The air humidity adjusting means preferably comprise only non-saturable air humidity adjusting means. Since such air humidity adjusting means cannot become saturated with moisture, the continuity of the operation of the device and the capacity of the device in respect of adjusting the air humidity of the air to be supplied to the internal space is ensured, so that neither discontinuity nor a variation relative to the predetermined moisture amount development line results.

In a preferred embodiment the non-saturable air humidity adjusting means comprise a cooling-based dehumidification system, preferably a cooling system with a plate heat exchanger.

With the device according to the present invention the moisture content in seeds to be treated with the device can progress in accordance with a desired progression which can be set completely freely, i.e. in accordance with the predetermined moisture amount development line, during the treatment process. This enables the seeds to be moistened and/or dried in highly controlled manner.

Because a highly controlled and stable treatment process with a predetermined moisture change rate of the amount of the amount of moisture in the seeds is made possible, the device enables both the process of priming and the process of drying to be performed thereby in said controlled manner, since any desired moisture amount development line can be set and be followed. Both the priming process and the immediately following drying process can hereby be performed in highly controlled manner. This means that the moisture content in the seeds can be adjusted in accordance with any desired progression, which can be both variable and constant.

In a preferred embodiment of the device the treatment process is a drying process and the moisture amount development line is a descending line.

With the device a drying process can therefore be provided whereby primed seeds are dried in a manner such that the priming is stopped sufficiently on the one hand and, on the other, no shrinkage cracks occur in the membranes of the seeds, which does happen regularly in current uncontrolled drying processes.

The device particularly provides a drying process wherein the total amount of moisture in the plurality of seeds decreases gradually due to evaporation in accordance with a predetermined moisture amount decrease per unit of time. This prevents shrinkage cracks from occurring in the membranes of the seeds due to the drying process. Shrinkage cracks have been found to be a significant cause of decreased seed quality and the storage life of primed seeds. Since these shrinkage cracks are at least substantially prevented with the device, the proportion of seeds not having the desired quality in respect of speed and uniformity of germination is limited to a minimum. The storage life of the seeds is also increased.

Because the device enables the total amount of moisture in the plurality of seeds to decrease gradually, a very gradual and slow, and thereby natural, manner of evaporation of moisture from the seeds can be achieved with the device. This has been found to be highly favourable for the preservation of the seed quality of primed seeds.

In a preferred embodiment the descending line is an at least substantially straight line, such that the total amount of moisture in the plurality of seeds decreases at least linearly. It has been found that a linear decrease of the total amount of moisture in the plurality of seeds over a long drying period of 24 hours, 48 hours, 72 hours or more—depending on the type of seed—results in a very high seed quality with hardly any or no shrinkage cracks.

It is noted that the device is not only suitable for treating seeds, but also for treating other products, such as foods, foodstuffs and medicines.

In a preferred embodiment the moisture amount development line represents a moisture amount decrease per unit of time which is smaller than or equal to the difference of an initial total amount of moisture in the plurality of seeds at the start of the treatment period and a desired lower total final amount of moisture in the plurality of seeds at the end of the treatment period per 24 hours, preferably per 48 hours and more preferably per 72 hours.

Because the device enables the relative humidity of the air in the area surrounding the seeds to progress such that the amount of moisture in seeds follows a predetermined moisture amount development line, a highly controlled and stable drying process with a drying period of 24 hours, 48 hours or 72 hours or more with a constant moisture decrease rate can be enabled. Primed seeds can hereby be dried in a manner such that the priming is stopped sufficiently on the one hand and, on the other, no shrinkage cracks occur in the membranes of the seeds, which does happen in current uncontrolled drying processes.

It is noted in this respect that the treatment period depends on the moisture releasing and moisture absorbing properties of the type of seed, the desired temperature and the desired flow rate of the air in the internal space. It is important that, with the treatment with the above specified moisture amount decrease gradients, a natural way of evaporation can be emulated and the occurrence of shrinkage cracks in the membranes of the seeds during the treatment process is thereby at least substantially prevented.

In a preferred embodiment the control means are further configured to control the air temperature adjusting means such that the temperature of the air present in the internal space is at least substantially constant. It has been found that a constant temperature is favourable for the seed quality of the seeds treated with the device.

In a preferred embodiment the control means are further configured to control the air displacing means such that the flow rate is at least substantially constant.

In a preferred embodiment the moisture amount information is the weight of the plurality of seeds and the moisture amount information obtaining means are weight determining means configured to determine the weight of the plurality of seeds, the moisture amount development line is a weight development line along which the weight of the plurality of seeds must run during the treatment period of the treatment process, and the control means are configured to control the air humidity adjusting means during the treatment period of the treatment process on the basis of the weight obtained by the weight determining means, such that the relative humidity of the air present in the internal space is such that the total amount of moisture in the plurality of seeds follows the weight development line.

The weight determining means preferably comprise measuring means for directly measuring the weight of the seeds for drying. By measuring the weight of the seeds for drying in a direct manner information about the actual amount of moisture in the seeds is obtained directly. In other words, the amount of moisture in the seeds is not deduced from data from measurements which are performed elsewhere in the device and/or are merely indicative of the amount of moisture in the seeds. In this latter case the data provide merely an indication of the amount of moisture and not the exact amount of moisture at the time of measuring. As a result, a discrepancy may result between the measured amount of moisture and the actual amount of moisture in the seeds. This results in the drying process not progressing in accordance with the desired moisture amount development line/drying curve, which may result in a significant proportion of the dried seeds not having the desired quality in respect of speed and uniformity of germination after drying thereof. Conversely, by directly measuring the weight of the seeds for drying information is obtained about the actual amount of moisture in the seeds at the time of measuring. On the basis of this information the control means of the device are able to control the air humidity adjusting means during the treatment period of the treatment process on the basis of the weight obtained by the weight determining means with an accuracy such that the relative humidity of the air present in the internal space is such that the total amount of moisture in the plurality of seeds follows the weight development line precisely, i.e. without discrepancies and without delay.

In a preferred embodiment the weight development line comprises a weight decrease per unit of time which is smaller than or equal to the difference of an initial total weight of the plurality of seeds at the start of the treatment process and a desired lower final weight of the plurality of seeds at the end of the treatment process per 24 hours, preferably per 48 hours and more preferably per 72 hours.

It is noted in this respect that the treatment period depends on the moisture releasing and moisture absorbing properties of the type of seed, the desired temperature and the desired flow rate of the air in the internal space. It is important that, with the treatment with the above specified weight decrease gradients, a natural way of evaporation can be emulated and the occurrence of shrinkage cracks in the membranes of the seeds during the treatment process is thereby at least substantially prevented.

In a preferred embodiment the device further comprises data entry means configured for entry of information about the moisture amount development line. Depending on the type of seed and depending on the desired treatment process, i.e. the desired drying and/or humidifying process, it is therefore possible to enter information on the basis of which the control means adjust the relative humidity of the air in the container, such that the total amount of moisture in the plurality of seeds progresses in accordance with the moisture amount development line.

In a preferred embodiment the data entry means are further configured for entry of goal weight information about a goal weight of the plurality of seeds, and the control means are further configured to determine the total amount of moisture in the plurality of seeds on the basis of the weight determined by the weight determining means and the goal weight.

In a preferred embodiment the goal weight of the plurality of seeds is equal to the dry weight of the plurality of seeds.

In a preferred embodiment the data entry means are further configured for entry of a total duration of the treatment period of the treatment process during which the plurality of seeds must be treated by the device, and the control means are further configured to control the air humidity adjusting means such that the weight of the plurality of seeds present in the internal space does not equal the goal weight until the treatment period has elapsed.

In a preferred embodiment the data entry means are further configured for entry of a treatment temperature at which the seeds must be treated, and the control means are further configured to control the air temperature adjusting means such that the temperature of the air to be supplied to the internal space is equal to the treatment temperature.

In a preferred embodiment the data entry means are further configured for entry of a treatment flow rate at which the seeds must be treated, and the control means are further configured to control the air displacing means such that the flow rate is equal to the treatment flow rate.

In a preferred embodiment the device further comprises an air channel which extends outside the container between the air outlet and the air inlet, such that the air outlet is in fluid connection with the air inlet via the air channel, wherein the air displacing means are configured to return air to the air inlet from the internal space via successively the air outlet and the air channel, wherein the air humidity adjusting means and the air temperature adjusting means are arranged successively between the air outlet and the air inlet, wherein the air humidity adjusting means and the air temperature adjusting means interact with the air in the air channel, and wherein the air humidity adjusting means comprise an air dehumidifier configured to reduce the relative humidity of the air in the air channel and the air temperature adjusting means comprise an air heater configured to increase the temperature of the air in the air channel.

In a preferred embodiment the air dehumidifier comprises a cooling system configured to cool the air in the air channel to a point below the dew point of the air.

In a preferred embodiment the cooling system comprises a plate heat exchanger for recovering heat released to the cooling system by the air in the air channel.

In a preferred embodiment the air humidity adjusting means comprise an air humidifier configured to increase the relative humidity of the air in the air channel.

In a preferred embodiment the device further comprises a filter which is arranged upstream of the air humidity adjusting means as seen in the direction of displacement of the air in the air channel, and is configured to filter dust residues from the air coming from the internal space.

In a preferred embodiment the weight determining means comprise weighing sensors which are arranged under the container and are configured to measure a total weight of the container and the plurality of seeds present in the internal space.

In a preferred embodiment the device further comprises container moving means for moving the container such that the seeds of the plurality of seeds contained by the container are set into motion such that each of the seeds is exposed to the air present in the internal space over its whole outer surface.

In a preferred embodiment the device further comprises an air distributing device configured to distribute the air to be supplied to the internal space over the internal space.

In a preferred embodiment the air distributing device comprises an elongate air distributing channel which extends in the internal space and is in fluid connection with the air inlet, and wherein a plurality of feed ports are provided on a longitudinal side of the air distributing channel, toward which the plurality of seeds in the internal space face, for the purpose of feeding the air to be supplied to the internal space to the internal space.

In a preferred embodiment the feed ports are distributed uniformly over the internal space.

In a preferred embodiment the container comprises a drying drum which is rotatable about its longitudinal axis.

In a preferred embodiment the device further comprises drying drum drive means for rotary driving of the drying drum, and the control means are configured to control the drying drum drive means to control a rotation speed of the drying drum.

In a preferred embodiment the data entry means are further configured for entry of a drying rotation speed at which the drying drum must be rotated, and the control means are further configured to control the drying drum such that the rotation speed is equal to the drying rotation speed.

In a preferred embodiment the control means are configured to periodically stop the drying drum in order to be able to determine the weight of the plurality of seeds in the internal space.

According to a second aspect, the present invention provides a method for treating seeds, comprising of arranging a plurality of seeds for drying in an internal space of a closable container, supplying air to the internal space and discharging air present in the internal space from the internal space at a flow rate, obtaining moisture amount information about a total amount of moisture in the plurality of seeds for drying, determining a moisture amount development line along which the total amount of moisture in the plurality of seeds must run during a treatment period of a treatment process of the method, and adjusting a relative humidity of the air to be supplied to the internal space during the treatment period of the treatment process on the basis of the moisture amount information, such that the relative humidity of the air present in the internal space is such that the total amount of moisture in the plurality of seeds follows the moisture amount development line.

The relative humidity of the air to be supplied to the internal space is preferably only adjusted by non-saturable air humidity adjusting means. Since such air humidity adjusting means cannot become saturated with moisture, the continuity and the capacity of the method in respect of adjusting the air humidity of the air to be supplied to the internal space is ensured, so that neither a discontinuity nor a variation relative to the predetermined moisture amount development line results.

In a preferred embodiment the non-saturable air humidity adjusting means comprise a cooling-based dehumidification system, preferably a cooling system with a plate heat exchanger.

With the method according to the present invention the moisture content in seeds to be treated with the method can progress in accordance with a desired progression, which can be set completely freely, during the treatment process. This enables the seeds to be moistened and/or dried in highly controlled manner.

Because a highly controlled and stable treatment process with a predetermined moisture change rate of the amount of moisture in the seeds is made possible, the method enables both the process of priming and the process of drying to be performed thereby in said controlled manner, since any desired moisture amount development line can be set and be followed. Both the priming process and the immediately following drying process can hereby be performed in highly controlled manner. This means that the moisture content in the seeds can be adjusted in accordance with any desired progression, which can be both variable and constant.

In a preferred embodiment of the method the treatment process is a drying process and the moisture amount development line is a descending line.

With the method a drying process can therefore be provided whereby primed seeds are dried in a manner such that the priming is stopped sufficiently on the one hand and, on the other, no shrinkage cracks occur in the membranes of the seeds, which does happen in current uncontrolled drying processes.

The method particularly provides for a drying process wherein the total amount of moisture in the plurality of seeds decreases gradually due to evaporation in accordance with a predetermined moisture amount decrease per unit of time. This prevents shrinkage cracks from occurring in the membranes of the seeds due to the drying process. Shrinkage cracks have been found to be a significant cause of decreased seed quality and the storage life of primed seeds. Since these shrinkage cracks are at least substantially prevented with the method, the proportion of seeds not having the desired quality in respect of speed and uniformity of germination is limited to a minimum. The storage life of the seeds is also increased.

Because the method enables the total amount of moisture in the plurality of seeds to decrease gradually, a very gradual and slow, and thereby natural, manner of evaporation of moisture from the seeds can be achieved with the method. This has been found to be highly favourable for the preservation of the seed quality of primed seeds.

In a preferred embodiment the descending line is an at least substantially straight line, such that the total amount of moisture in the plurality of seeds decreases at least linearly. It has been found that a linear decrease of the total amount of moisture in the plurality of seeds over a long drying period of 24 hours, 48 hours, 72 hours or more—depending on the type of seed—results in a very high seed quality with hardly any or no shrinkage cracks.

It is noted that the method is not only suitable for treating seeds, but also for treating other products such as foods, foodstuffs and medicines.

In a preferred embodiment the moisture amount development line represents a moisture amount decrease per unit of time which is smaller than or equal to the difference of an initial total amount of moisture in the plurality of seeds at the start of the treatment period and a desired lower total final amount of moisture in the plurality of seeds at the end of the treatment period per 24 hours, preferably per 48 hours and more preferably per 72 hours.

Because the method enables the relative humidity of the air in the area surrounding the seeds to progress such that the amount of moisture in seeds follows a predetermined moisture amount development line, a highly controlled and stable drying process with a drying period of 24 hours, 48 hours or 72 hours or more with a constant moisture decrease rate can be enabled. Primed seeds can hereby be dried in a manner such that the priming is stopped sufficiently on the one hand and, on the other, no shrinkage cracks occur in the membranes of the seeds, which does happen in current uncontrolled drying processes.

It is noted in this respect that the treatment period depends on the moisture releasing and moisture absorbing properties of the type of seed, the desired temperature and the desired flow rate of the air in the internal space. It is important that, with the treatment with the above specified moisture amount decrease gradients, a natural way of evaporation can be emulated and the occurrence of shrinkage cracks in the membranes of the seeds during the treatment process is thereby at least substantially prevented.

In a preferred embodiment the method further comprises of adjusting the temperature of the air to be supplied to the internal space, such that the temperature of the air present in the internal space is at least substantially constant. It has been found that a constant temperature is favourable for the seed quality of the seeds treated with the method.

In a preferred embodiment the method further comprises of keeping the flow rate at least substantially constant.

In a preferred embodiment obtaining the moisture amount information comprises of obtaining weight information about the plurality of seeds, the moisture amount development line is a weight development line along which the weight of the plurality of seeds must run during the treatment period of the treatment process, and the step of adjusting the relative humidity comprises of adjusting the relative humidity of the air to be supplied to the internal space during the treatment period of the treatment process on the basis of the weight information, such that the relative humidity of the air present in the internal space is such that the total amount of moisture in the plurality of seeds follows the weight development line.

Obtaining the weight information about the plurality of seeds preferably comprises of directly measuring the weight of the plurality of seeds. By measuring the weight of the seeds for drying in a direct manner information about the actual amount of moisture in the seeds is obtained directly. In other words, the amount of moisture in the seeds is not deduced from data from measurements which are performed elsewhere in the device and/or are merely indicative of the amount of moisture in the seeds. In this latter case the data provide merely an indication of the amount of moisture and not the exact amount of moisture at the time of measuring. As a result, a discrepancy may result between the measured amount of moisture and the actual amount of moisture in the seeds. This results in the drying process not progressing in accordance with the desired moisture amount development line/drying curve, which may result in a significant proportion of the dried seeds not having the desired quality in respect of speed and uniformity of germination after drying thereof. Conversely, by directly measuring the weight of the seeds for drying information is obtained about the actual amount of moisture in the seeds at the time of measuring. On the basis of this information the relative humidity of the air to be supplied to the internal space can be accurately adjusted, such that the relative humidity of the air present in the internal space is such that the total amount of moisture in the plurality of seeds follows the weight development line precisely, i.e. without discrepancies and without delay.

In a preferred embodiment the weight development line represents a weight decrease per unit of time which is smaller than or equal to the difference of an initial total weight of the plurality of seeds at the start of the treatment process and a desired lower final weight of the plurality of seeds at the end of the treatment process per 24 hours, preferably per 48 hours and more preferably per 72 hours.

It is noted in this respect that the treatment period depends on the moisture releasing and moisture absorbing properties of the type of seed, the desired temperature and the desired flow rate of the air in the internal space. It is important that, with the treatment with the above specified moisture amount decrease gradients, a natural way of evaporation can be emulated and the occurrence of shrinkage cracks in the membranes of the seeds during the treatment process is thereby at least substantially prevented.

In a preferred embodiment the adjusting of the relative humidity and the adjusting of the temperature of the air to be supplied to the internal space comprises of successively lowering the temperature and raising the temperature of the air to be supplied to the internal space.

In a preferred embodiment the supplying of air to the internal space and the discharging of air present in the internal space from the internal space comprises of recirculating the air.

In a preferred embodiment the recirculating of the air comprises of filtering the air discharged from the internal space.

In a preferred embodiment the supplying of air to the internal space comprises of distributing the supplied air uniformly over the internal space.

In a preferred embodiment the method further comprises of moving the container such that the seeds of the plurality of seeds arranged in the container are set into motion such that each of the seeds is exposed to the air present in the internal space over its whole outer surface.

The present invention will be further elucidated with reference to the following figures, which show preferred embodiments of the device and method according to the present invention and are not intended to limit the scope of protection of the invention in any way, wherein:

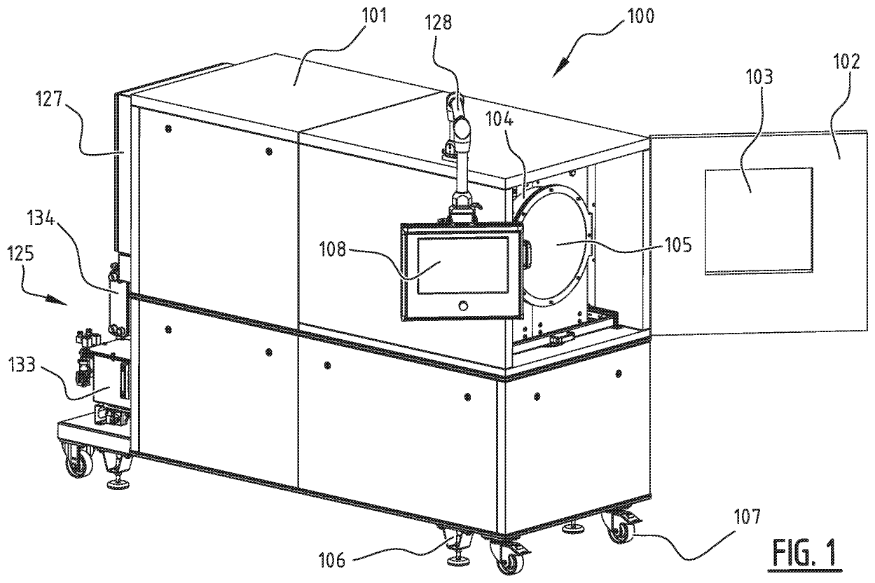

FIG. 1 shows a perspective view of a preferred embodiment of the device according to the present invention;

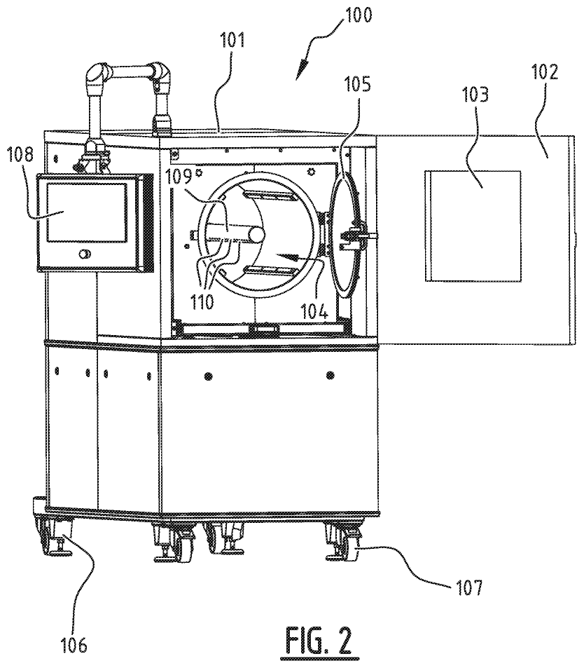

FIG. 2 shows another perspective view of the device of FIG. 1;

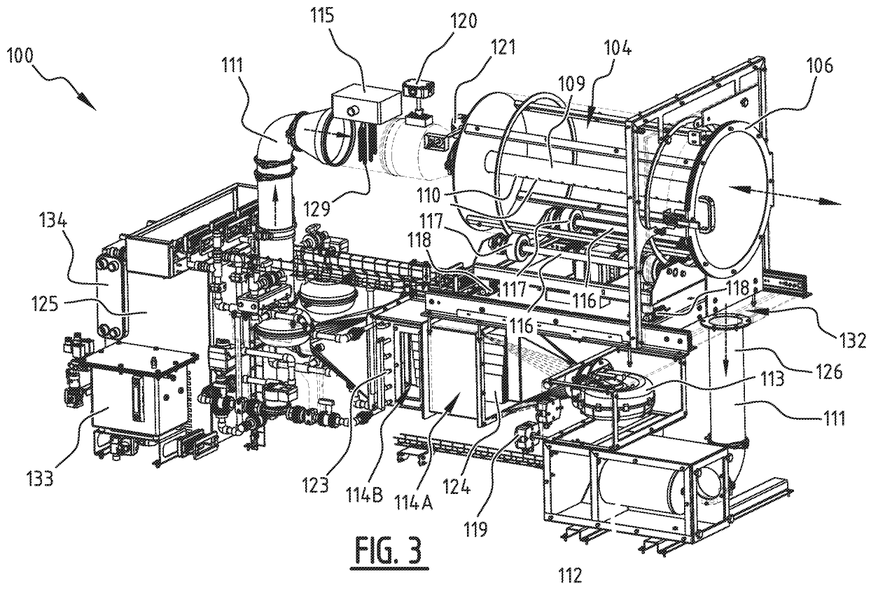

FIG. 3 shows a perspective view of the device of FIGS. 1 and 2 without housing;

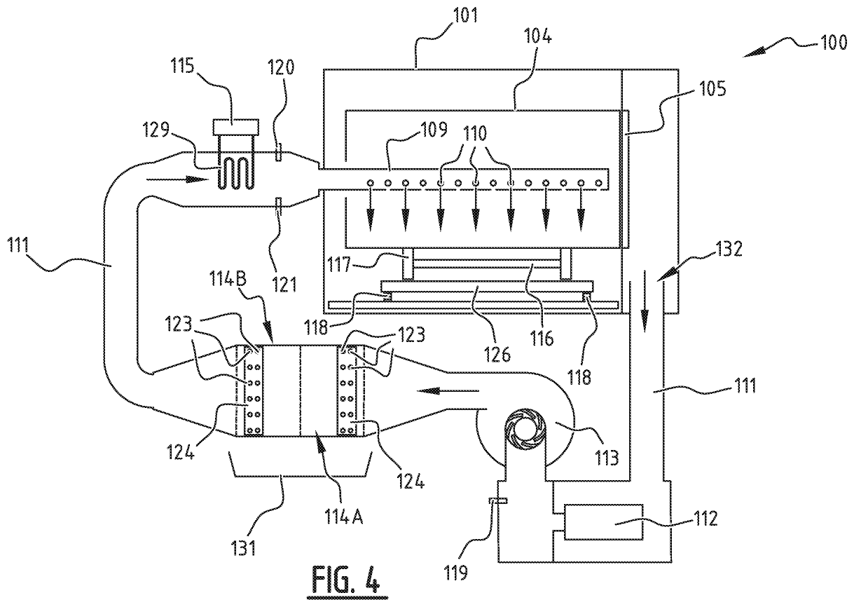

FIG. 4 shows a schematic longitudinal sectional view of the view of FIG. 3;

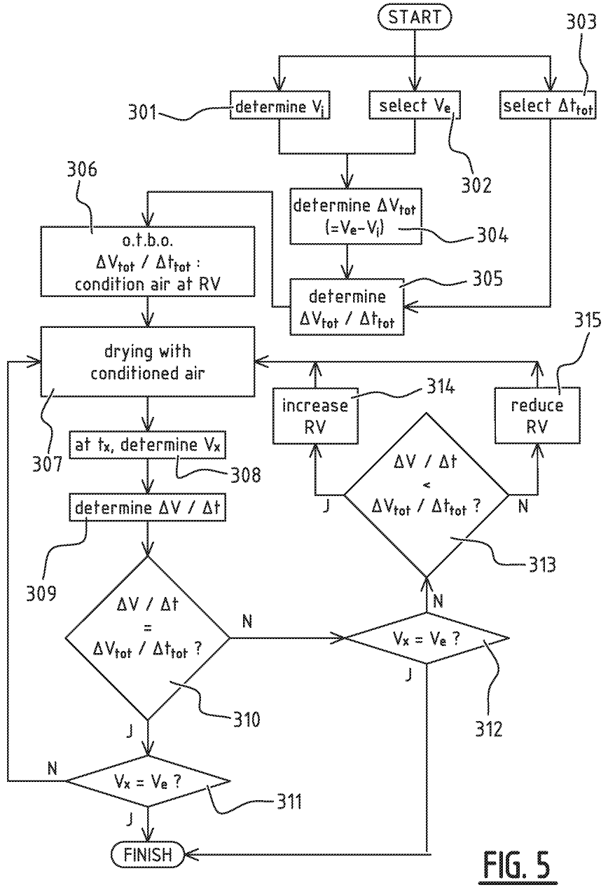

FIG. 5 shows a flow diagram of a preferred embodiment of the method according to the present invention; and

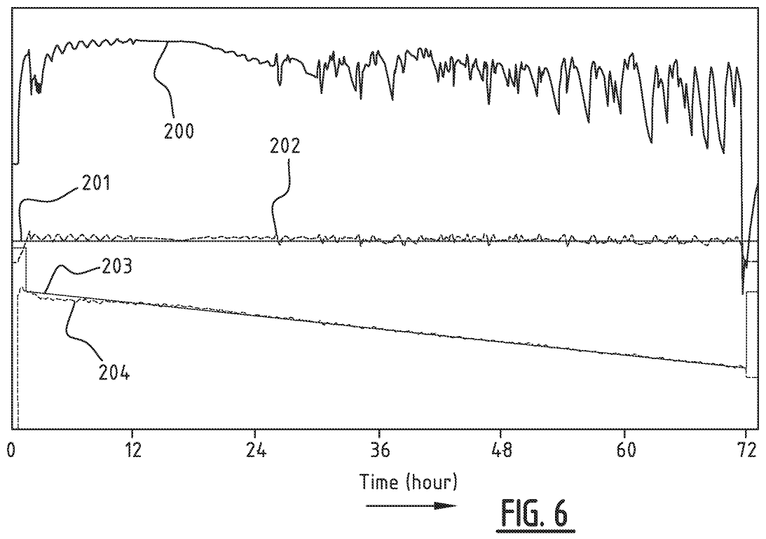

FIG. 6 shows data curves of measurement data of sensors of the device according to the present invention.

FIG. 1 shows a perspective view of a preferred embodiment of the device according to the present invention. FIG. 1 specifically shows a device/dryer 100, wherein components of the dryer 100 are situated in a housing 101. The housing 101 has a door 102 which provides access to a drying drum 104 of dryer 100. The door 102 has a window 103 which functions as access opening for opening a drum door 105 of drying drum 104. The drum door 105 in turn provides access to the internal space of drying drum 104. Housing 101 can be placed on a ground surface in stable manner using adjustable feet 106. Housing 101 also has on an underside thereof wheels 107 in order to enable displacement of dryer 100. For controlling dryer 100 a touchscreen 108 is provided which is configured for entry of information such as the drying weight and the minimum drying period of the seeds to be dried in the internal space of drying drum 104. By means of touchscreen 108 it is also possible to select a moisture amount development line, such as a drying curve, along which the seeds must be dried; i.e. the selected curve determines how the moisture content in the seeds must progress during the total drying period of a drying process carried out using device 100. In order to prevent human error, the correct selection of the moisture amount development line/drying curve is ensured in that a user of dryer 100 need only enter the type of seed. By entering the correct type of seed the user will automatically select the correct moisture amount development line/drying curve. Because any desired moisture amount development line can be selected, seeds can not only be dried in device 100, but also be moistened using device 100. Touchscreen 108 also provides information about the treatment process/drying process, such as the change in the amount of moisture in the seeds per unit of time. Touchscreen 108 is connected to housing 101 using an adjustable arm 128 rotatable about several pivot axes. Reference is made in this respect to FIG. 2.

Situated in the internal space of drying drum 104 is an air feed channel 109 which is configured to supply conditioned air to drying drum 104—see FIG. 3. For this purpose the air feed channel 109 has air feed ports 110 which are directed toward an underside of drying drum 104 and which are arranged in air feed channel 109 such that the air to be supplied is distributed uniformly over the whole length of drying drum 104. As is visible in FIGS. 2, 3 and 4, the longitudinal axis of air feed channel 109 lies on the rotation axis of drying drum 104. Arranged on the side of drying drum 104 lying opposite door 105 is a recess through which the air feed channel 109 is arranged.

The air to be supplied through the feed ports 110 of air feed channel 109 is conditioned outside the drying drum, such that an air speed, temperature and relative humidity of the supplied air are such that the seeds dry slowly and gradually. The rate of drying is regulated in controlled manner using four weighing sensors 118 which measure the total weight of drying drum 104 and the seeds present in the internal space of drying drum 104. The four weighing sensors 118 are arranged under corner points of a rectangular frame on which drying drum 104 rests. The rectangular frame has two rails 126 which extend parallel to each other and along which the drying drum 104 can be slid into and out of housing 101 in the direction of the rotation axis of drying drum 104. The air to be supplied to the internal space of drying drum 104 is conditioned discharge air which is discharged from drying drum 104 on side 132 of drying drum 104 and is returned to air feed channel 109 through air guiding channel 111. The air coming from the internal space of drying drum 104 here first passes through a first portion of air guiding channel 111 and is then carried through a filter unit 112 in order to filter dust residues present in the discharge air from the air. Filter unit 112 has its own adjustable cleaning system. Situated behind filter unit 112 is a fan 113 which generates the airflow in air guiding channel 111 and in the internal space of drying drum 104. After the air in air guiding channel 111 has moved through fan 113, the air moves through a first heat exchanger (cooler) 114A connected to a cooling machine 125. The first heat exchanger 114A has the function of cooling the return air and reducing the humidity of the return air to a desired level. The first heat exchanger 114A consists of copper tubes 123 in combination with lamella 124, via which heat transfer takes place. Using cooling machine 125 the first heat exchanger 114A is cooled by a mixture of water and glycol. The first heat exchanger 114A is kept at the desired temperature via a controlled three-way valve. By guiding the air along the first heat exchanger 114A the air is cooled to a point below the dew point of the return air (i.e. the air coming from drying drum 104) so that the moisture in the air condenses onto the surface of the first heat exchanger 114A. This reduces the moisture content. This moisture comes from the seeds present in drying drum 104. The temperature of first heat exchanger 114A is regulated such that dehumidification takes place at the correct rate. Situated under first heat exchanger 114A is a drip tray 131 for collecting the condensation. Situated downstream of the first heat exchanger 114A is a second heat exchanger (heater) 114B. The embodiment of this second heat exchanger 114B is the same as that of the first heat exchanger 114A. The second heat exchanger 114B has the function of heating the cooled return air from first heat exchanger 114A, if necessary, by means of heat recovery, the heat for which comes from a plate exchanger 134. Plate exchanger 134 draws its heat from hot gases of cooling machine 125. Second heat exchanger 114B is kept at the desired temperature via a controlled three-way valve. After the air has been guided through second heat exchanger 114B the air is carried upward through a second portion of air guiding channel 111 and then heated to a desired temperature by a heating unit 115 with heating element 129. The heated, dehumidified air is then supplied at a flow rate determined by the fan speed via the feed ports 110 of air feed channel 109 to the internal space of drying drum 104, in which the seeds for drying are located. The seeds can be arranged loose in drying drum 104 or in an air-permeable bag which is placed in drying drum 104 as a whole.

In addition to weighing sensors 118, whereby a decrease in the weight of the seeds arranged in drying drum 104 due to evaporation of moisture in the seeds can be measured, the dryer has a plurality of sensors 119, 120, 121. Sensors 119 and 120 are each configured to measure the temperature of the relative humidity of air. Sensor 119 is located between filter unit 112 and fan 113. Sensor 119 is therefore located upstream of heat exchangers 114A, 114B, as seen in the direction of the airflow through air guiding channel 111. The temperature and the relative humidity of the air coming from drying drum 104 can therefore be measured with sensor 119. Sensor 120 is located between heating unit 115 and drying drum 104. Sensor 120 is therefore located at a position immediately upstream of air feed channel 109 and feed openings 110, as seen in the direction of the airflow through air guiding channel 111. The temperature and the relative humidity of the air to be supplied to drying drum 104 can therefore be measured with sensor 120. Sensor 121 measures the air speed of the air to be supplied to drying drum 104.

On the basis of the data of sensors 119, 120, 121 and on the basis of the information about the weight of the seeds in drying drum 104, this being provided by weighing sensors 118, the fan 113, cooling machine 125 and heating unit 115 are controlled such that the seeds are dried slowly and steadily, i.e. in stepwise manner or gradual manner, in accordance with a predetermined weight decrease per unit of time in order to prevent shrinkage cracks in the membranes of the seeds.

During drying of the seeds in drying drum 104 the cylindrical drying drum 104 is rotated about its central cylinder axis. For this purpose drying drum 104 is driven by a motor 130 which drives one of two shafts 116 under drying drum 104. Arranged at outer ends of shafts 116 are wheels 117 on which drying drum 104 rests and on which the drying drum rotates about its central cylinder axis.

The fan 113, the assembly of cooling machine 125 and plate exchanger 114 and the heating unit 115 are controlled such that respectively the flow rate, the relative humidity and the temperature of the air to be supplied through the feed ports 110 of air feed channel 109 are such that the weight and thereby the amount of moisture in the seeds present in the internal space of drying drum 104 decreases with a constant weight decrease per unit of time over a minimum period of 24 hours, preferably 48 hours and more preferably 72 hours, depending on the type of seed that must be dried with the dryer 100.

The drying process which can be brought about with the shown device 100 is as it were an emulation of a natural way of evaporating the seeds. The drying air is here moved over the moist seeds by fanning and then carried through the shown cooling system (i.e. inter alia cooling machine 125, conduits 123 and plate heat exchanger 114) in order to be dehumidified. If the return temperature from drying drum 104 becomes lower than the set desired return temperature due to moisture evaporation from the seeds, the air is heated until the desired temperature is reached. Heating of the return air takes place after the air has been carried through the cooling system. By accurately controlling the dew point (or the relative humidity) the desired moisture percentage is extracted from the return air.

The drying process is controlled on the basis of measurements of the weight of the seeds during the drying process in order to realize a sustained and accurate gradual drying process. The drying process is a continuous and closed drying process and has a control and information system (not shown) on the basis of weight information about the seeds for drying/the product for drying. The drying process takes as its starting point the dry starting weight of the seeds for drying. The seeds which are moistened after a treatment with water or other agents have increased in weight after being centrifuged. By entering the dry starting weight, and automatically weighing the wet weight of the seeds in the control system of dryer 100 when dryer 100 is started, dryer 100 will automatically dry the seeds to the dry starting weight in a desired drying time which can be preset. By measuring the weight of the seeds for drying in a direct manner information about the actual amount of moisture in the seeds is obtained directly. In other words, the amount of moisture in the seeds is not deduced from data from measurements which are performed elsewhere in the device and/or are merely indicative of the amount of moisture in the seeds. In this latter case the data provide merely an indication of the amount of moisture and not the exact amount of moisture at the time of measuring. As a result, a discrepancy may result between the measured amount of moisture and the actual amount of moisture in the seeds. This results in the drying process not progressing in accordance with the desired moisture amount development line/drying curve, which may result in a significant proportion of the dried seeds not having the desired quality in respect of speed and uniformity of germination after drying thereof. Conversely, by directly measuring the weight of the seeds for drying information is obtained about the actual amount of moisture in the seeds at the time of measuring. On the basis of this real-time information about the actual amount of moisture, which is provided by weighing sensors 118, the fan 113, cooling machine 125 and heating unit 115 are controlled such that the seeds follow a predetermined weight decrease curve more precisely, i.e. without discrepancies and without delay. In this way the seeds are dried in a highly controlled manner in accordance with an ideal drying curve, wherein shrinkage cracks in the membranes of the seeds are prevented. The seeds can hereby otherwise also be moistened in highly controlled manner in accordance with a predetermined ideal moistening curve.

The minimum drying time which can be entered by means of touchscreen 108 is 24 hours, and the maximum drying time is more than 72 hours. The drying time also depends on the moisture releasing properties of the type of seed, the desired drying temperature and the desired ventilation rate. A natural way of evaporation can be emulated in this way. Dryer 100 is further equipped with a humidification system 133 which humidifies the air. In this way the absolute moisture content of the air is made higher than the absolute moisture content of the seeds. The seeds in drying drum 104 are hereby unable to release any more moisture. This option is applied in dryer 100 for the purpose of sustained drying of small batches of seed with a total dry weight below 1 kg. This option can be switched on and off as desired.

FIG. 5 shows a flow diagram of a preferred embodiment of the method according to the present invention. In a first step 301 an initial amount of moisture Vᵢ in the plurality of seeds for drying is determined. This initial amount of moisture Vᵢ can be determined by weighing the seeds at the start of the drying process and comparing this to the dry weight of the seeds.

A desired final amount of moisture Vₑ is then selected in step 302. This final amount of moisture Vₑ equals the desired final weight of the seeds. Also selected is a drying period Δtₜₒₜ during which the seeds must be dried such that the final weight of the seeds is not reached until the drying period Δtₜₒₜ has elapsed (see step 303).

On the basis of the determined initial amount of moisture (the determined starting weight of the seeds) and the desired final amount of moisture Vₑ (the desired final weight of the seeds) it is possible to determine a desired total moisture decrease ΔVₜₒₜ which is equal to the difference between the final amount of moisture Vₑ and the initial amount of moisture Vᵢ. Reference is made to step 304 of FIG. 5. The desired gradient of the moisture decrease, i.e. the desired moisture decrease rate ΔVₜₒₜ/Δtₜₒₜ, is then determined in step 305 on the basis of the desired total moisture decrease ΔVₜₒₜ and the desire drying period Δtₜₒₜ.

On the basis of the desired moisture decrease rate ΔVₜₒₜ/Δtₜₒₜ determined in step 305 the air to be applied to the seeds is conditioned such that the relative humidity RV of the air in the vicinity of the seeds results in a desired moisture decrease with the desired gradient (see step 306). The seeds are then exposed to the conditioned air with the correct relative humidity RV and thereby dried in step 307.

In order to ensure that the seeds are dried in accordance with the desired drying curve the amount of moisture Vₓ in the seeds is measured multiple times at fixed times tₓ during the drying period of the drying process by means of weighing them (see step 308).

The momentary moisture decrease rate ΔV/Δt can be determined on the basis of the elapsed time between two measurements of the weight of the seeds and the weight difference (see step 309).

The determined moisture decrease rate ΔV/Δt is then compared to the desired moisture decrease rate ΔVₜₒₜ/Δtₜₒₜ(see step 310).

If the determined moisture decrease rate ΔV/Δt is equal to the desired decrease rate ΔVₜₒₜ/Δtₜₒₜ(see step 310→J) and the set final weight has not yet been reached (see step 311→N), the drying process is continued with the drying with the previously conditioned air, i.e. with the same relative humidity, see step 307.

If the determined moisture decrease rate ΔV/Δt is not equal to the desired decrease rate ΔVₜₒₜ/Δtₜₒₜ(see step 310→N), the set final weight has not yet been reached (see step 312→N) and the determined moisture decrease rate ΔV/Δt is smaller than the desired decrease rate ΔVₜₒₜ/Δtₜₒₜ (see step 313→J), the air to be supplied to the seeds is conditioned such that the relative humidity thereof is increased (see step 314). It is noted that both ΔVₜₒₜ/Δtₜₒₜ and ΔV/Δt have a negative value in the case of a moisture decrease. If the determined moisture decrease rate ΔV/Δt therefore has a negative value which is smaller than the negative value of the desired decrease rate ΔVₜₒₜ/Δtₜₒₜ, the amount of moisture in the seeds is decreasing too quickly. For this reason the relative humidity RV of the air to be supplied to the seeds is increased.

If the determined moisture decrease rate ΔV/Δt is not equal to the desired decrease rate ΔVₜₒₜ/Δtₜₒₜ(see step 310→N), the set final weight has not yet been reached (see step 312→N) and the determined moisture decrease rate ΔV/Δt is greater than the desired decrease rate ΔVₜₒₜ/Δtₜₒₜ(see step 313→N), the air to be supplied to the seeds is conditioned such that the relative humidity thereof is reduced (see step 315).

The degree of increase and decrease of the relative humidity RV is determined on the basis of the magnitude of the difference between the determined moisture decrease rate ΔV/Δt and the desired decrease rate ΔVₜₒₜ/Δtₜₒₜ.

The method is then continued from step 307. When the seeds have reached the desired final amount of moisture (the desired final weight), the drying process according to the method will be stopped.

In summary, the dryer 100 is configured to perform the method of FIG. 5. If during the drying process the measured weight of the seeds is higher than the automatically calculated desired weight, dryer 100 will automatically lower the dew point in order to dry faster. If during the drying process the measured weight of the seeds is lower than the automatically calculated desired weight, dryer 100 will automatically raise the dew point in order to dry more slowly and, if necessary, switch on humidification system 133.

If the desired dry weight is reached during the drying process, the user of dryer 100 can then opt beforehand to switch dryer 100 off or have it switch to the conditioning phase. In this conditioning phase the temperature and relative humidity of the air coming from drying drum 104 are regulated on the basis of set values associated with the conditioning, while in the drying process the temperature and relative humidity of the air to be supplied to drying drum 104 are regulated. During the conditioning the dryer remains active until it is switched off manually.

Using device 100 a treatment process can therefore be performed whereby the moisture content in seeds can be modified in controlled and also steady manner. Device 100 and the method particularly enable seeds to be dried in a very slow and controlled manner. This is achieved by allowing the seeds to evaporate in natural manner and discharging the moisture released from the seeds at a low air speed and dehumidifying it outside drying drum 104, wherein the temperature and the flow rate of the air to which the seeds are exposed are kept at least substantially constant.

More specifically, the seeds can be dried in accordance with a desired drying curve which can be preset. An example of such a drying curve is line 203 in FIG. 6. The drying curve represents a weight progression of the seeds during a drying period of about 72 hours (see the X-axis of FIG. 6).

The desired temperature of the drying air can also be preset. In FIG. 6 the desired temperature during the drying period is represented by line 201. The temperature must therefore be kept constant during the whole drying period.

As discussed above, the device has sensors for measuring the relative humidity and the temperature of the air, and for measuring the weight of the seeds. Moisture decrease and the rate of the moisture decrease in the seeds are determined on the basis of the weight of the seeds measured by the weight sensors. The measured weight is represented in FIG. 6 by line 204.

If the measured weight decreases too quickly, the dew point of the drying air is raised. The relative humidity of the drying air is therefore increased. This can for instance be done by cooling the return air to lesser extent and thereby dehumidifying it to lesser extent or, if necessary, by humidifying with the humidification system.

Conversely: if the measured weight decreases too slowly, the dew point of the drying air is lowered. The relative humidity of the drying air is therefore reduced. This can for instance be done by cooling the return air to greater extent and thereby extracting more moisture from the air by deposition thereof.

The progression of the relative humidity of the air regulated by device 100 is represented by line 200 in FIG. 6. It is clearly visible that the relative humidity fluctuates to obtain a linearly decreasing weight line 204 which follows the drying curve 203 as closely as possible.

The temperature of the drying air is also measured and adjusted, such that it is at least substantially constant and thereby follows the desired temperature line 201 as closely as possible.

With the device and method according to the present invention the moisture content in seeds can progress in accordance with a desired progression which can be set completely freely. This enables seeds to be moistened and/or dried in highly controlled manner. Because a highly controlled and stable drying process of 24 hours, 48 hours or 72 hours or more with a constant moisture decrease rate is made possible, primed seeds can be dried in a manner such that the priming is stopped sufficiently on the one hand and, on the other, no shrinkage cracks occur in the membranes of the seeds, which does happen in current uncontrolled drying processes.

Finally, it is noted that the device and method enable both the process of priming and the process of drying to be performed thereby in said controlled manner, since any desired moisture amount development line can be set and be followed. Both the priming process and the immediately following drying process can hereby be performed in highly controlled manner. This means that the moisture content in the seeds can be adjusted in accordance with any desired progression, both dynamically and statically.

The present invention is not limited to the shown embodiments but also extends to other embodiments falling within the scope of protection of the appended claims.

1. A device for treating seeds, comprising:
a closable container with an internal space for containing a plurality of seeds therein, comprising an air inlet and an air outlet which are each in fluid connection with the internal space;
air displacing means configured to supply air via the air inlet to the internal space at a flow rate and to discharge the air present in the internal space via the air outlet;
air humidity adjusting means configured to adjust a relative humidity of the air to be supplied to the internal space;
air temperature adjusting means configured to adjust a temperature of the air to be supplied to the internal space;
moisture amount information obtaining means configured to obtain moisture amount information about a total amount of moisture in the plurality of seeds; and
control means configured to control the air humidity adjusting means on the basis of the moisture amount information obtained by the moisture amount information obtaining means during a treatment period of a treatment process for treating the plurality of seeds, such that the relative humidity of the air present in the internal space is such that the total amount of moisture in the plurality of seeds follows a predetermined moisture amount development line, along which the total amount of moisture in the plurality of seeds must run during the treatment period of the treatment process.

2. The device according to claim 1, wherein the treatment process is a drying process and wherein the moisture amount development line is a descending line; and wherein the descending line is an at least substantially straight line, such that the total amount of moisture in the plurality of seeds decreases at least linearly.

3. (canceled)

4. The device according to claim 1, wherein the control means are further configured to control the air temperature adjusting means such that the temperature of the air present in the internal space is at least substantially constant; and/or wherein the control means are further configured to control the air displacing means such that the flow rate is at least substantially constant.

5. (canceled)

6. The device according to claim 1, wherein the moisture amount information is the weight of the plurality of seeds and the moisture amount information obtaining means are weight determining means configured to determine the weight of the plurality of seeds, wherein the moisture amount development line is a weight development line along which the weight of the plurality of seeds must run during the treatment period of the treatment process, and wherein the control means are configured to control the air humidity adjusting means during the treatment period of the treatment process on the basis of the weight obtained by the weight determining means, such that the relative humidity of the air present in the internal space is such that the total amount of moisture in the plurality of seeds follows the weight development line.

7. The device according to claim 6, further comprising data entry means configured for entry of information about the moisture amount development line; wherein the data entry means are further configured for entry of goal weight information about a goal weight of the plurality of seeds, wherein the control means are further configured to determine the total amount of moisture in the plurality of seeds on the basis of the weight determined by the weight determining means and the goal weight.

8. (canceled)

9. The device according to claim 6, wherein the data entry means are further configured for entry of a total duration of the treatment period of the treatment process during which the plurality of seeds must be treated by the device, wherein the control means are further configured to control the air humidity adjusting means such that the weight of the plurality of seeds present in the internal space does not equal the goal weight until the treatment period has elapsed.

10. The device according to claim 7, wherein the data entry means are further configured for entry of a treatment temperature at which the seeds must be treated, wherein the control means are further configured to control the air temperature adjusting means such that the temperature of the air to be supplied to the internal space is equal to the treatment temperature; and/or
wherein the data entry means are further configured for entry of a treatment flow rate at which the seeds must be treated, wherein the control means are further configured to control the air displacing means such that the flow rate is equal to the treatment flow rate.

11. (canceled)

12. The device according to claim 1, further comprising an air channel which extends outside the container between the air outlet and the air inlet, such that the air outlet is in fluid connection with the air inlet via the air channel, wherein the air displacing means are configured to return air to the air inlet from the internal space via successively the air outlet and the air channel, wherein the air humidity adjusting means and the air temperature adjusting means are arranged successively between the air outlet and the air inlet, wherein the air humidity adjusting means and the air temperature adjusting means interact with the air in the air channel, and wherein the air humidity adjusting means comprise an air dehumidifier configured to reduce the relative humidity of the air in the air channel and the air temperature adjusting means comprise an air heater configured to increase the temperature of the air in the air channel.

13. The device according to claim 12, wherein the air dehumidifier comprises a cooling system configured to cool the air in the air channel to a point below the dew point of the air; wherein the cooling system comprises a plate heat exchanger for recovering heat released to the cooling system by the air in the air channel; and/or wherein the air humidity adjusting means comprise an air humidifier configured to increase the relative humidity of the air in the air channel.

14-15. (canceled)

16. The device according to claim 12, further comprising a filter which is arranged upstream of the air humidity adjusting means as seen in the direction of displacement of the air in the air channel, and is configured to filter dust residues from the air coming from the internal space.

17. The device according to claim 6, wherein the weight determining means comprise weighing sensors which are arranged under the container and are configured to measure a total weight of the container and the plurality of seeds present in the internal space.

18. The device according to claim 1, further comprising:
container moving means for moving the container such that the seeds of the plurality of seeds contained by the container are set into motion such that each of the seeds is exposed to the air present in the internal space over its whole outer surface; and/or
an air distributing device configured to distribute the air to be supplied to the internal space over the internal space; and/or
wherein the air distributing device comprises an elongate air distributing channel which extends in the internal space and is in fluid connection with the air inlet, and wherein a plurality of feed ports are provided on a longitudinal side of the air distributing channel, toward which the plurality of seeds in the internal space face, for the purpose of feeding the air to be supplied to the internal space to the internal space; and/or
wherein the feed ports are distributed uniformly over the internal space; and/or
wherein the container comprises a drying drum which is rotatable about its longitudinal axis.

19-22. (canceled)

23. The device according to claim 18, further comprising drying drum drive means for rotary driving of the drying drum, wherein the control means are configured to control the drying drum drive means to control a rotation speed of the drying drum; and wherein the data entry means are further configured for entry of a drying rotation speed at which the drying drum must be rotated, wherein the control means are further configured to control the drying drum such that the rotation speed is equal to the drying rotation speed.

24. (canceled)

25. The device according to claim 18, wherein the control means are configured to periodically stop the drying drum in order to be able to determine the weight of the plurality of seeds in the internal space.

26. A method for treating seeds, comprising:
arranging a plurality of seeds for drying in an internal space of a closable container;
supplying air to the internal space and discharging air present in the internal space from the internal space at a flow rate;
obtaining moisture amount information about a total amount of moisture in the plurality of seeds for drying;
determining a moisture amount development line along which the total amount of moisture in the plurality of seeds must run during a treatment period of a treatment process of the method; and
adjusting a relative humidity of the air to be supplied to the internal space during the treatment period of the treatment process on the basis of the moisture amount information, such that the relative humidity of the air present in the internal space is such that the total amount of moisture in the plurality of seeds follows the moisture amount development line.

27. The method according to claim 26, wherein the treatment process is a drying process and wherein the moisture amount development line is a descending line; and wherein the descending line is an at least substantially straight line, such that the total amount of moisture in the plurality of seeds decreases at least linearly.

28. (canceled)

29. The method according to claim 26, further comprising:
adjusting the temperature of the air to be supplied to the internal space, such that the temperature of the air present in the internal space is at least substantially constant; and/or
keeping the flow rate at least substantially constant.

30. (canceled)

31. The method according to claim 26, wherein obtaining the moisture amount information comprises of obtaining weight information about the plurality of seeds, wherein the moisture amount development line is a weight development line along which the weight of the plurality of seeds must run during the treatment period of the treatment process, and wherein the step of adjusting the relative humidity comprises of adjusting the relative humidity of the air to be supplied to the internal space during the treatment period of the treatment process on the basis of the weight information, such that the relative humidity of the air present in the internal space is such that the total amount of moisture in the plurality of seeds follows the weight development line.

32. The method according to claim 29, wherein the adjusting of the relative humidity and the adjusting of the temperature of the air to be supplied to the internal space comprises of successively lowering the temperature and raising the temperature of the air to be supplied to the internal space.

33. The method according to claim 26, wherein the supplying of air to the internal space and the discharging of air present in the internal space from the internal space comprises of recirculating the air; and/or
wherein the recirculating of the air comprises of filtering the air discharged from the internal space; and/or
wherein the supplying of air to the internal space comprises of distributing the supplied air uniformly over the internal space; and/or
wherein the method further comprises moving the container such that the seeds of the plurality of seeds arranged in the container are set into motion such that each of the seeds is exposed to the air present in the internal space over its whole outer surface.

34-36. (canceled)
